(19) United States
(12) Patent Application Publication
(10) Pub. No.: US 2007/0296349 A1
(43) Pub. Date: Dec. 27, 2007

(54) Method For Operation Of A High Pressure Discharge Lamp Operating Device For A High Pressure Discharge Lamp And High Pressure Discharge Lamp With An Operating Device

(75) Inventors: Michael Bonigk, Berlin (DE); Matthias Lau, Berlin (DE); Ralf Romberg, Munchen (DE)

Correspondence Address: OSRAM SYLVANIA INC, 100 ENDICOTT STREET, DANVERS, MA, 01923, US

(73) Assignee: Patent-Treuhand-Gesellschaft Fur Elektrische Gluhlampen MBH, Munchen (DE)

(21) Appl. No.: 11/660,704

(22) PCT Filed: Jul. 28, 2005
(86) PCT No.: PCT/DE05/01334

§ 371 Date: Jul. 30, 2007

(30) Foreign Application Priority Data
Aug. 31, 2004 (DE) 10 2004 042 462.4

(51) Int. Cl. H05B 41/24

(52) U.S. Cl. 315/246

(57) ABSTRACT

The invention relates to a method and a device for operation of ah high pressure discharge lamp with a low-frequency current of alternating polarity, whereby the high pressure discharge lamp is operated during a start phase at a higher power than the rated power thereof. According to the invention, the high pressure discharge lamp is provided with a current, at least during the start phase, with a commutation time of less than or equal to 40 microseconds.

The invention relates to a method for operating a high-pressure discharge lamp in accordance with the precharacterizing clause of patent claim 1 and to a corresponding operating device and to a high-pressure discharge lamp with an operating device.

I. Prior Art

Such a method is disclosed, for example, in the German laid-open specification DE 39 04 926 A1. This document describes a method and a device for operating a high-pressure discharge lamp, in particular a metal-halide high-pressure discharge lamp for a vehicle headlight, with a current of alternating polarity and a power greater than the rated power during a starting phase of the high-pressure discharge lamp.

Measurements have shown that illumination systems with the abovementioned lamps emit electromagnetic radiation which causes interference, for example in the television and radio reception in the vehicle. This interference is particularly pronounced during the starting phase of the high-pressure discharge lamp.

The laid-open specification US 2003/0030855 A1 describes a method and a device for operating a high-pressure discharge lamp, in particular a metal-halide high-pressure discharge lamp for a vehicle headlight, with a current of alternating polarity. In order to improve the electromagnetic compatibility of the device or the illumination system, this document proposes providing a further capacitor in parallel with the electrolyte capacitor of the smoothing circuit, which further capacitor interacts with a switched mode power supply and a transformer.

II. Description of the Invention

The object of the invention is to provide a method and a device for operating a high-pressure discharge lamp which, using simple means, make it possible to improve the electromagnetic compatibility of the illumination system.

This object is achieved according to the invention by the features of patent claims 1 and 3, respectively. Particularly advantageous embodiments of the invention are described in the dependent patent claims.

The method according to the invention for operating a high-pressure discharge lamp with a low-frequency current of alternating polarity and with an increased power supply in comparison with the rated power during a starting phase of the high-pressure discharge lamp is characterized by the fact that, at least during the starting phase, a current whose commutation time is less than or equal to 40 microseconds is applied to the high-pressure discharge lamp. The term commutation time of the current in this case refers to the time span which the current requires to implement the change in polarity and, in the process, either to achieve the value +I_{N} in the positive half-cycle for the first time, starting from the value −I_{N} in the negative half-cycle, or to achieve the value −I_{N} in the negative half-cycle for the first time, starting from the value +I_{N} in the positive half-cycle, if the variable I_{N} is the absolute value for the rated value of the current. The term low-frequency current in this case means a current whose frequency is less than or equal to 1000 hertz.

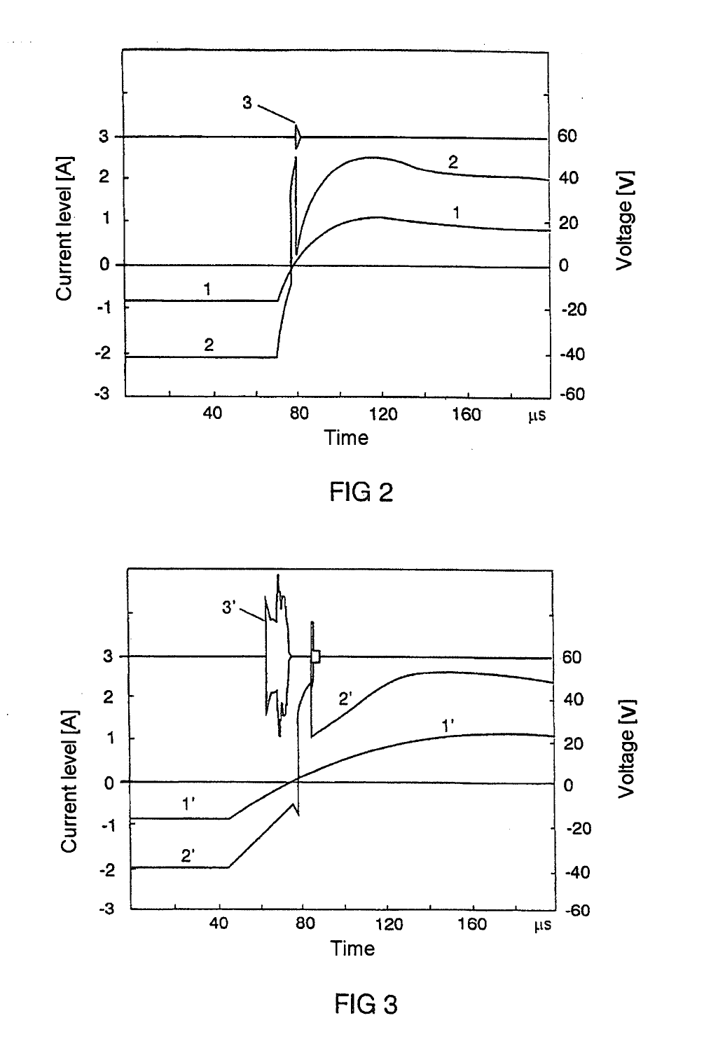

As a result, the emission of electromagnetic interference during the starting phase of the high-pressure discharge lamp in which the lamp is operated at a multiple of its rated power is considerably reduced and a corresponding improvement in the electromagnetic compatibility of the illumination system is ensured. In particular, use of the operating method according to the invention avoids interference in the television and radio reception in a motor vehicle which has high-pressure discharge lamps as light sources in the headlight. FIGS. 2 and 3 show a comparison of the operating method according to the invention with the operating method according to the prior art.

Preferably, a current whose commutation time is less than or equal to 40 microseconds is applied to the high-pressure discharge lamp throughout the period of the starting phase and also once the starting phase has ended, in order to improve the electromagnetic compatibility of the illumination system.

The device according to the invention for operating a high-pressure discharge lamp with a low-frequency current of alternating polarity comprises a transformer, which is equipped with at least one secondary winding, for igniting the gas discharge in the high-pressure discharge lamp, the inductance of the at least one secondary winding being dimensioned such that the commutation time of the lamp current of the high-pressure discharge lamp is less than or equal to 40 microseconds. As is documented by the comparative measurements in FIGS. 2 and 3, the dimensioning of the inductance of the at least one secondary winding of the ignition transformer has a decisive influence on the commutation time of the lamp current. By suitably dimensioning the inductance of the abovementioned secondary winding, the electromagnetic compatibility of the abovementioned device or the illumination system can be improved.

Measurements have shown that the electromagnetic interference caused by the illumination system can be reduced to a sufficient extent if the inductance, which is effective during lamp operation, of the at least one secondary winding, through which the lamp current flows, of the ignition transformer has a value of less than or equal to 1 mH. This can be ensured by virtue of the fact that either the at least one secondary winding of the ignition transformer has an inductance of at most 1 mH or else a capacitor is connected in series with the at least one secondary winding, which capacitor forms an electrical short circuit for the ignition voltage pulses and, during the starting phase of the high-pressure discharge lamp and thereafter, brings about partial compensation of the inductance of the at least one secondary winding, with the result that the inductance, which is effective in the lamp circuit, of the at least one secondary winding is less than or equal to 1 mH. The commutation time of the lamp current is thus at most 40 microseconds.

In accordance with the preferred exemplary embodiment of the invention, the device contains an ignition device, the transformer, which is equipped with the at least one secondary winding, being in the form of an ignition transformer of the ignition device. The ignition device merely comprises a few components and has a spatially compact design, with the result that it can be arranged in the base of the high-pressure discharge lamp.

### III. DESCRIPTION OF THE PREFERRED EXEMPLARY EMBODIMENT

The invention will be explained in more detail below with reference to a preferred exemplary embodiment. In the drawing:

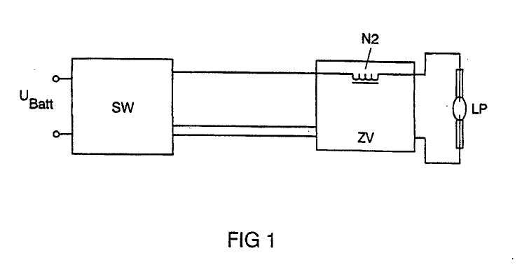

FIG. 1 shows a block circuit diagram of the preferred exemplary embodiment of the device according to the invention for operating a high pressure discharge lamp,

FIG. 2 shows the profile over time of the lamp current and the lamp voltage of the high-pressure discharge lamp during the operating method according to the invention and the interference signal received by the copper antenna, and

FIG. 3 shows the profile over time of the lamp current and the lamp voltage of the high-pressure discharge lamp during the conventional operating method and the interference signal received by the copper antenna.

FIG. 1 illustrates schematically a simplified block circuit diagram of the operating device for carrying out the operating method according to the invention. The operating device is used for operating a mercury-free metal-halide high-pressure discharge lamp having a rated power of 35 watts, which is intended for use as a light source of a motor vehicle headlight. Accordingly, the operating device is fed by the system voltage of the motor vehicle. The operating device for the high-pressure discharge lamp LP contains a voltage converter SW and an ignition device ZV. The voltage converter SW is used for supplying power to the high-pressure discharge lamp LP and for regulating the lamp power as well as for supplying voltage to the ignition device ZV. The ignition device ZV comprises a transformer, whose secondary winding N2 is connected in series with the discharge path of the high-pressure discharge lamp LP. During the ignition phase of the high-pressure discharge lamp LP, the transformer is used for supplying the high-pressure discharge lamp LP with high-voltage pulses. The components of the ignition device ZV can be arranged within the lamp base or else together with the other components of the operating device in a housing close to the vehicle headlight. The ignition device ZV is in the form of a pulse ignition device in a known manner. The voltage converter SW contains, in a known manner, a full-bridge inverter, the high-pressure discharge lamp LP being arranged in its bridge branch. Details on the voltage converter SW are given, for example, on pages 212 to 218 of the book “Betriebsgeräte und Schaltungen fur elektrische Lampen” [Operating devices and circuits for electric lamps] by C. H. Sturm and E. Klein, published by Siemens Aktiengesellschaft, 6th edition, 1992. Details on the ignition device ZV are disclosed, for example, in the European laid-open specification EP 0 933 974 A1.

Once it has been switched on, the ignition device ZV produces high-voltage pulses for igniting the gas discharge in the high-pressure discharge lamp LP. Once the gas discharge has been ignited, the lamp LP is operated at a multiple of its rated power in the subsequent starting phase of the high-pressure discharge lamp LP in order to vaporize the metal halides in the discharge vessel of the high-pressure discharge lamp LP and to induce light emission in a period of time which is as short as possible. During the starting phase and thereafter, a substantially square-wave current of alternating polarity is applied to the lamp LP by means of the voltage converter SW. The frequency of this current is in the range of from 250 hertz to 750 hertz. During the starting phase of the high-pressure discharge lamp LP and also during normal lamp operation once the starting phase has ended, the lamp current flows through the secondary winding N2 of the transformer. In order to ensure good electromagnetic compatibility of the illumination system, the secondary winding N2 of the transformer has an inductance of only 0.7 mH. As a result, the commutation time of the lamp current during the starting phase and also during operation thereafter is only 25 microseconds, as can be seen in FIG. 2. Owing to this short commutation time, the illumination system only emits a small amount of electromagnetic radiation, which does not result in any interference in the television and radio reception in the motor vehicle.

In comparison with this, FIG. 3 illustrates the lamp current when using a secondary winding N2 of the transformer with an inductance of 4 mH. In this case, the commutation time is 84 microseconds. The electromagnetic interference caused by the illumination system is considerably more severe than in the operating method according to the invention shown in FIG. 2. In order to measure the electromagnetic interference (measurement curves 3 and 3′ in FIGS. 2 and 3), an oscilloscope and a copper antenna having a length of approximately 10 cm are used. The copper antenna is designed for measurements of the measurement curves 3 and 3′ at a predetermined distance from the high-pressure discharge lamp LP in order to make a comparison possible. In FIG. 2, in addition to measurement curve 3, the profile over time of the lamp current and the profile over time of the lamp voltage during a change in polarity are also illustrated in measurement curve 1 and measurement curve 2, respectively, the secondary winding N2 in this case having an inductance of 0.7 mH. In FIG. 3, in addition to measurement curve 3′, the profile over time of the lamp current and the profile over time of the lamp voltage during a change in polarity are also illustrated in measurement curve 1′ and measurement curve 2′, respectively, the secondary winding N2 in this case having an inductance of 4 mH.

In FIGS. 2 and 3, the time in microseconds is in each case plotted on the horizontal axis and, for the profile over time of the lamp current directly prior to and after a change in polarity during the starting phase, i.e. for the measurement curve 1 or 1′, the current level in amperes is plotted on the vertical axis at the left-hand edge of the abovementioned figures. For the profile over time of the lamp voltage directly prior to and after a change in polarity during the starting phase, i.e. for the measurement curve 2 or 2′, the voltage in volts is plotted on the vertical axis at the right-hand edge in FIGS. 2 and 3. The measurement curves 3 and 3′, which represent the interference signal received by the copper antenna, were not evaluated quantitatively since the absolute signal strength depends on the setup and the properties of the antenna. Here, qualitative comparison of the measurement curves 3 and 3′, which were determined by means of their experimental setup, is sufficient for proving the reduction in the interference signal owing to the operating method according to the invention.

1. A method for operating a high-pressure discharge lamp with a low-frequency current of alternating polarity, the high-pressure discharge lamp being operated during a starting phase at a power which is greater than its rated power, characterized in that, at least during the starting phase, a current whose commutation time is less than or equal to 40 microseconds is applied to the high-pressure discharge lamp.

2. The method for operating a metal-halide high-pressure discharge lamp in a vehicle headlight as claimed in claim 1.

3. A device for operating a high-pressure discharge lamp with a low-frequency current of alternating polarity, the device comprising a transformer, which is equipped with at least one secondary winding (N2), for igniting the gas discharge in the high-pressure discharge lamp (LP), characterized in that the inductance of the at least one secondary winding (N2) is dimensioned such that the commutation time of the current of the high-pressure discharge lamp (LP) is less than or equal to 40 microseconds.

4. The device as claimed in claim 3, characterized in that the at least one secondary winding (N2) is part of an ignition device.

5. The device as claimed in claim 3, characterized in that the effective inductance of the at least one secondary winding while the lamp current is flowing through it is less than or equal to 1 mH.

6. The device as claimed in claim 3, characterized in that the inductance of the at least one secondary winding is less than or equal to 1 mH.

7. A high-pressure discharge lamp having an ignition device as claimed in claim 4 arranged in the base of the high-pressure discharge lamp.

8. The metal-halide high-pressure discharge lamp for vehicle headlights as claimed in claim 7.
